(19) United States
(12) Patent Application Publication
(10) Pub. No.: US 2025/0164737 A1
(43) Pub. Date: May 22, 2025

(54) EXTENSION FOR A MAGNIFICATION THROW LEVER

(71) Applicant: Sheltered Wings, Inc. d/b/a Vortex Optics, Barneveld, WI (US)

(72) Inventors: Calen Havens, Barneveld, WI (US); Garrison Bollig, Barneveld, WI (US); Alexander Lewis, Barneveld, WI (US)

(21) Appl. No.: 18/759,504

(22) Filed: Jun. 28, 2024

Related U.S. Application Data
(60) Provisional application No. 63/511,494, filed on Jun. 30, 2023.

(51) Int. Cl. G02B 7/04; G02B 23/00

(52) U.S. Cl. CPC G02B 7/04; G02B 23/00

(57) ABSTRACT

The disclosure relates to viewing optics, and more particularly to an extension for a throw lever for a viewing optic.

### CROSS REFERENCE TO RELATED APPLICATIONS

This application claims priority to and is a non-provisional patent application of U.S. Provisional Patent Application No. 63/511,494 filed Jun. 30, 2023, which is incorporated herein by reference in its entirety.

### FIELD

The disclosure relates to viewing optics, and more particularly to an extension for a throw lever for a viewing optic.

### BACKGROUND

The magnification adjustment on a viewing optic can take many different styles and shapes. The magnification ring can take up most of the eyepiece, or it can be a small ring. More and more frequently, customers are using separate throw levers that attach to the magnification ring. The magnification throw lever provides mechanical advantage and allows the user to adjust their magnification setting quickly and ergonomically.

Some companies have taken to integrating the throw lever directly into the magnification adjustment. This is much stronger than a separately attached throw lever. However, even large magnification throw levers can be difficult to access if they are close to the turrets or another object like a Laser Range Finder.

Accordingly, the need exists for an extension for a magnification throw lever that can be used with a viewing optic.

### SUMMARY

In one embodiment, the disclosure relates to a viewing optic. In one embodiment, the disclosure relates to a viewing optic having a magnification ring with a magnification throw level coupled to the magnification ring. In another embodiment, the disclosure relates to an extension for a magnification throw lever for a viewing optic.

In one embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension coupled to the magnification throw lever.

In one embodiment, the extension is threaded into an insert inside the magnification throw lever. In another embodiment, the extension is a knurled metal extension. In another embodiment, the extension is a polymer wing. In another embodiment, the polymer wing is coupled to the magnification throw lever through a MLOK slot. In another embodiment, the extension is coupled to a ring that encircles the ocular assembly. In one embodiment, the extension and the ring are a single, integrated unit. In another embodiment, the extension is separable from the ring.

In one embodiment, the ring is a one-piece unit. In one embodiment, the ring is a continuous unit. In another embodiment, the ring is a solid, continuous unit. In another embodiment, the ring is a split-design. In one embodiment, the ring has ball bearings, and further wherein the ocular assembly has a groove to accept the ball bearings.

In one embodiment, the extension is a shroud. In another embodiment, the extension has a hook configured to aid a user in accessing the extension. In another embodiment, the extension is the length of the ocular assembly.

In another embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension coupled to the magnification throw lever, and an active display configured to generate an image, wherein the generated image and target image of the outward scene are combined in the first focal plane.

In one embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension coupled to the magnification throw lever.

In another embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension threaded into an insert inside the magnification throw lever.

In another embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and a polymer wing coupled to the magnification throw lever.

In another embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and a polymer wing coupled to the magnification throw lever via an MLOK slot.

In one embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension coupled to the magnification throw lever, wherein the extension is the length of the eyepiece, and a ring that encircles the ocular assembly.

In one embodiment, the disclosure relates to a viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension threaded into the magnification throw lever, wherein the extension is the length of the eyepiece, a ring that encircles the ocular assembly, and an active display configured to generate an image, wherein the generated image and target image of the outward scene are combined in the first focal plane.

In one embodiment, the disclosure relates to a viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, and an extension coupled to the magnification throw lever, and an active display configured to generate an image, wherein the generated image and target image of the outward scene are combined in the first focal plane.

In another embodiment, the disclosure relates to a viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, and an extension threaded into an insert inside the magnification throw lever, and an active display configured to generate an image, wherein the generated image and target image of the outward scene are combined in the first focal plane.

In one embodiment, the disclosure relates to a viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, a polymer wing coupled to the magnification throw lever, and an active display configured to generate an image, wherein the generated image and target image of the outward scene are combined in the first focal plane.

In one embodiment, the disclosure relates to a viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, a polymer wing coupled to the magnification throw lever via an MLOK slot, and an active display configured to generate an image, wherein the generated image and target image of the outward scene are combined in the first focal plane.

Other embodiments will be evident from a consideration of the drawings taken together with the detailed description provided below.

### BRIEF DESCRIPTION OF THE DRAWINGS

FIG. 1 is a diagram showing the optical components of a representative viewing optic.

FIG. 2 is a partial side view of an example of a firearm showing a viewing optic mounted on the barrel.

FIG. 3 is a representative, non-limiting depiction of a traditional magnification throw lever.

FIG. 4 is a representative, non-limiting depiction of an extension for a magnification throw lever as disclosed herein.

FIG. 5 is a representative, non-limiting depiction of an extension for a magnification throw lever as disclosed herein.

FIG. 6 is a representative, non-limiting depiction of an extension for a magnification throw lever as disclosed herein.

FIG. 7 is a representative, non-limiting depiction of an extension for a magnification throw lever as disclosed herein.

FIG. 8 is a representative, non-limiting depiction of an extension for a magnification throw lever as disclosed herein.

FIG. 9 is a representative, non-limiting depiction of an extension for a magnification throw lever as disclosed herein.

FIG. 10 is a representative, non-limiting depiction of an extension for a magnification throw lever as disclosed herein.

FIG. 11 is a representative, non-limiting depiction of an extension for a magnification throw lever as disclosed herein.

FIG. 12 is a representative, non-limiting depiction of an extension for a magnification throw lever as disclosed herein.

FIG. 13 is a representative, non-limiting depiction of an extension for a magnification throw lever as disclosed herein.

FIG. 14 is a representative, non-limiting depiction of an extension for a magnification throw lever as disclosed herein.

FIGS. 15A-15C are representative depictions of a viewing optic with an active display.

### DETAILED DESCRIPTION

The disclosure relates to covers for viewing optics and related devices. Certain preferred and illustrative embodiments of the invention are described below. The present invention is not limited to these embodiments.

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on”, “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, an “active display” comprises image-creating pixel modulation. In one embodiment, the active display is an emissive active display. Emissive active displays, including but not limited to Organic light-emitting diodes (OLED) and Light-Emitting Diodes (LED), feature the image and light source in a single device, and therefore an external light source is not required. This minimizes system size and power consumption, while providing exceptional contrast and color space. OLEDs are made from ultra-thin organic semiconducting layers, which light up when they are connected to voltage (charge carriers become injected and luminance mainly is proportional to the forward current). The major layers comprise several organic materials in sequence (for example, charge transport, blocking and emission layers—each with a thickness of several nanometers), which are inserted between an anode and a cathode. The terms “active display,” “digital display” and “microdisplay” are used interchangeably.

As used herein, “ballistics” is a way to precisely calculate the trajectory of a bullet based on a host of factors.

As used herein, an “erector sleeve” is a protrusion from the erector lens mount which engages a slot in the erector tube and/or cam tube or which serves an analogous purpose. This could be integral to the mount or detachable.

As used herein, an “erector tube” is any structure or device having an opening to receive an erector lens mount.

As used herein, the term “firearm” refers to any device that propels an object or projectile, for example, in a controllable flat fire, line of sight, or line of departure, for example, hand-guns, pistols, rifles, shotgun slug guns, muzzleloader rifles, single shot rifles, semi-automatic rifles and fully automatic rifles of any caliber direction through any media. As used herein, the term “firearm” also refers to a remote, servo-controlled firearm wherein the firearm has auto-sensing of both position and directional barrel orientation. The shooter is able to position the firearm in one location and move to a second location for target image acquisition and aiming. As used herein, the term “firearm” also refers to chain guns, belt-feed guns, machine guns, and Gattling guns. As used herein, the term firearm also refers to high elevation, and over-the-horizon, projectile propulsion devices, for example, artillery, mortars, canons, tank canons or rail guns of any caliber.

As used herein, M-Lok (Modular Lock) refers to a mounting system that allows you to attach accessories to a negative space mounting point.

As used herein, a “reticle,” in one embodiment, is an aiming pattern for a viewing optic, such as, but not limited to, a crosshair aiming point or other aiming pattern.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “outward scene” refers to a real-world scene, including but not limited to a target.

As used herein, the term “shooter” applies to either the operator making the shot or an individual observing the shot in collaboration with the operator making the shot.

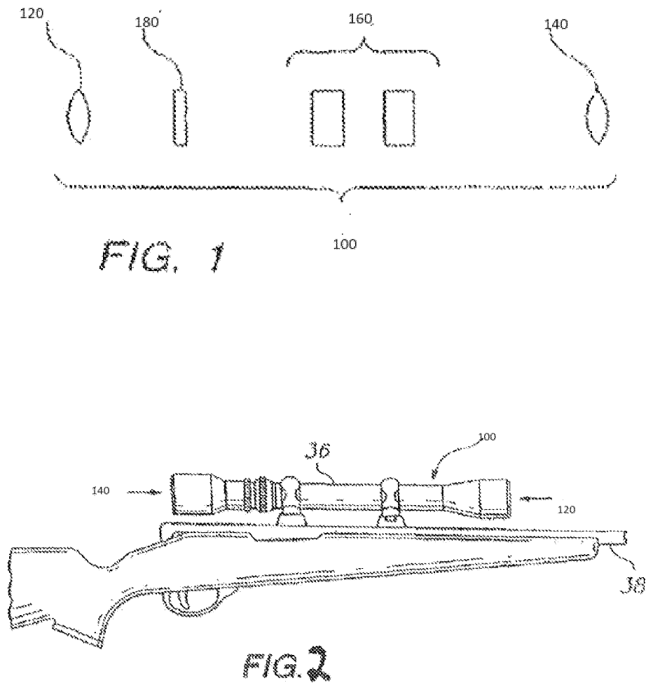

As exemplified in FIGS. 1 and 2, a viewing optic 100 (also referred to herein as a “scope”) includes a housing 36 that can be mounted in fixed relationship with a gun barrel 38. Housing 36 is preferably constructed from steel or aluminum, but can be constructed from virtually any durable, substantially rigid material that is useful for constructing optical equipment. Mounted in housing 36 at one end is an objective lens or lens assembly 120. Mounted in housing 36 at the opposite end is an ocular lens or lens assembly 140.

As used herein, the term “lens” refers to an object by means of which light rays, thermal, sonar, infrared, ultraviolet, microwave or radiation of other wavelength is focused or otherwise projected to form an image. It is well known in the art to make lenses from either a single piece of glass or other optical material (such as transparent plastic) which has been conventionally ground and polished to focus light, or from two or more pieces of such material mounted together, for example, with optically transparent adhesive and the like to focus light. Accordingly, the term “lens” as used herein is intended to cover a lens constructed from a single piece of optical glass or other material, or multiple pieces of optical glass or other material (for example, an achromatic lens), or from more than one piece mounted together to focus light, or from other material capable of focusing light. Any lens technology now known or later developed finds use with the present invention. For example, any lens based on digital, hydrostatic, ionic, electronic, magnetic energy fields, component, composite, plasma, adoptive lens, or other related technologies may be used. Additionally, moveable or adjustable lenses may be used. As will be understood by one having skill in the art, when the scope 10 is mounted to, for example, a gun, rifle or weapon 38, the objective lens (that is, the lens furthest from the shooter's eye) 12 faces the target, and the ocular lens (that is, the lens closest to the shooter's eye) 14 faces the shooter's eye.

Other optical components that may be included in housing 36 include variable power optical components 160 for a variable power scope. Such components 160 typically include magnifiers and erectors. Such a variable power scope permits the user to select a desired power within a predetermined range of powers. For example, with a 3-12× 50 scope, the user can select a lower power (e.g., 3×50) or a high power (e.g., 12×50) or any power along the continuous spectrum.

Finally, a reticle assists the shooter in hitting the target. The reticle is typically (but not necessarily) constructed using optical material, such as optical glass or plastic, or similar transparent or translucent material, and takes the form of a disc or wafer with substantially parallel sides. A reticle may, for example, be constructed from wire, spider web, nano-wires, an etching, or may be analog or digitally printed, or may be projected (for example, on a surface) by, for example, a mirror, video, holographic projection, or other suitable means on one or more wafers of material. In the embodiments provided herein, the reticles are etched or wire. The etching may be filled in with a reflective material, for example, titanium oxide, which illuminates when a light or diode powered by, for example, a battery, chemical or photovoltaic source, is rheostatically switched on compensating for increasing (+) or decreasing (−) light intensity.

The reticle is mounted anywhere between the ocular lens 140 and the objective lens 120 of FIG. 1. In one embodiment, the viewing optic has a main optical system comprised of an objective lens system that focuses an image from a target down to a first focal plane (hereafter referred to as the “FFP Target Image”), followed by an erector lens system that inverts the FFP Target Image and focuses it to a second focal plane (hereafter referred to as the “SFP Target Image”), an eyepiece lens system that collimates the SFP Target Image so that it can be observed by the human eye, and a second optical system. In some embodiments, a beam combiner is placed between the objective lens system and the first focal plane.

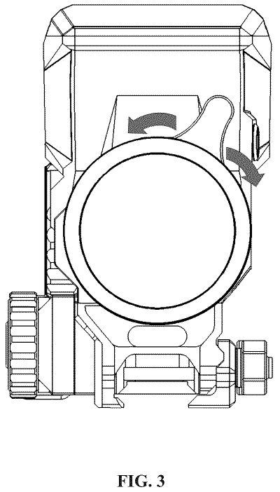

On a variable power optic the magnification ring and by extension the magnification throw lever are rotated to increase and decrease the magnification of the optic. A representative embodiment is shown in FIG. 3.

In one embodiment, the disclosure relates to an extension for a magnification throw lever. In one embodiment, the extension for the throw lever increases the surface area of the throw lever. In another embodiment, the extension for the throw lever cantilevers the throw lever over the eyepiece of a variable power optic to aid users in manipulating the magnification throw lever.

In one embodiment, the magnification throw lever can be used with any variable power optic including but not limited to a riflescope, and a spotting scope. In one embodiment, extension for the magnification throw lever can be used with a variable power optic that has a Laser Rangefinder (LRF) mounted to the viewing optic, wherein the extension allows easier access to the throw lever. In another embodiment, the magnification throw lever can be used with a viewing optic that has an integrated display system.

In one embodiment, the magnification throw lever may be integrated into the magnification throw ring. In another embodiment, the magnification throw lever may be a separately attachable magnification throw lever. In one embodiment, the magnification throw lever may be any height or size.

In one embodiment, the extension may be made of metal, plastic, polymer, a plastic/polymer combination or other appropriate material. In one embodiment, the extension may be of any size, shape, or dimension that is useful to the user. In one embodiment, the extension may be textured to provide greater grip.

In one embodiment, the extension could be oriented forward, backward, right, left, or in any direction or combination of directions that would help the user manipulate the magnification adjustment.

In one embodiment, the extension may be threaded directly into the magnification throw lever or threaded into an insert. In one embodiment, the extension may pass through a hole in the magnification throw lever and be secured via a nut and bolt/screw on the other side.

In one embodiment, the hole may be proprietary, or it may adhere to a standard such as the Magpul M-Lok attachments. The extension may also utilize a dovetail style attachment for extra strength and security and the magnification throw lever may have a cover for the dovetail when the extension is not in use.

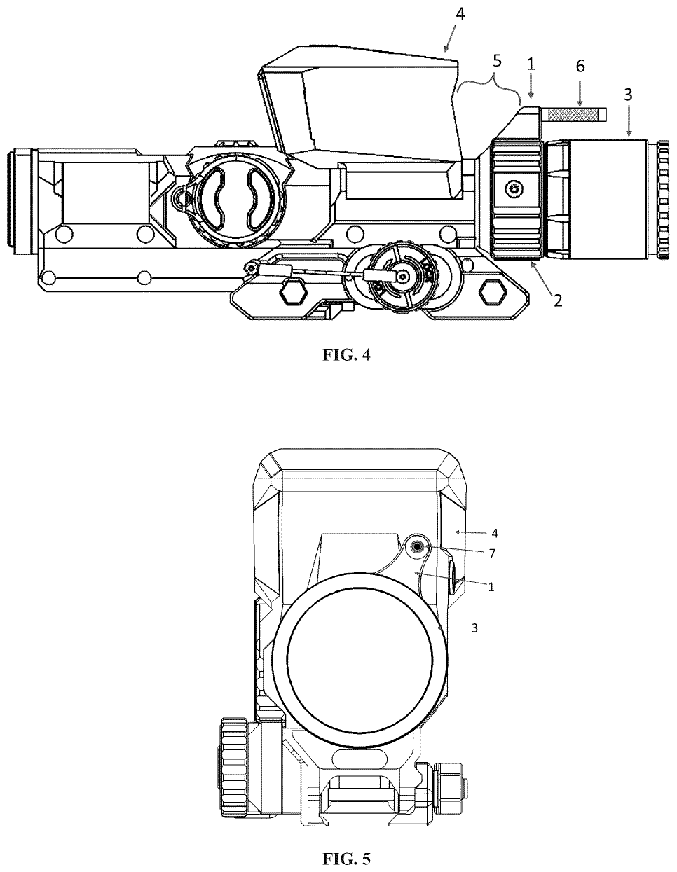

A representative non-limiting embodiment of an extension for a magnification throw lever is shown in FIGS. 4 and 5. The magnification throw lever (1) is permanently attached to the magnification ring (2). In this example, the eyepiece (3) does not rotate. A LRF (4) is in front of the eyepiece, reducing the working area (5) that a user can use to manipulate the magnification throw lever (1). The magnification throw lever extension is a knurled metal extension (6) that is threaded into an insert (7) inside the magnification throw lever (1).

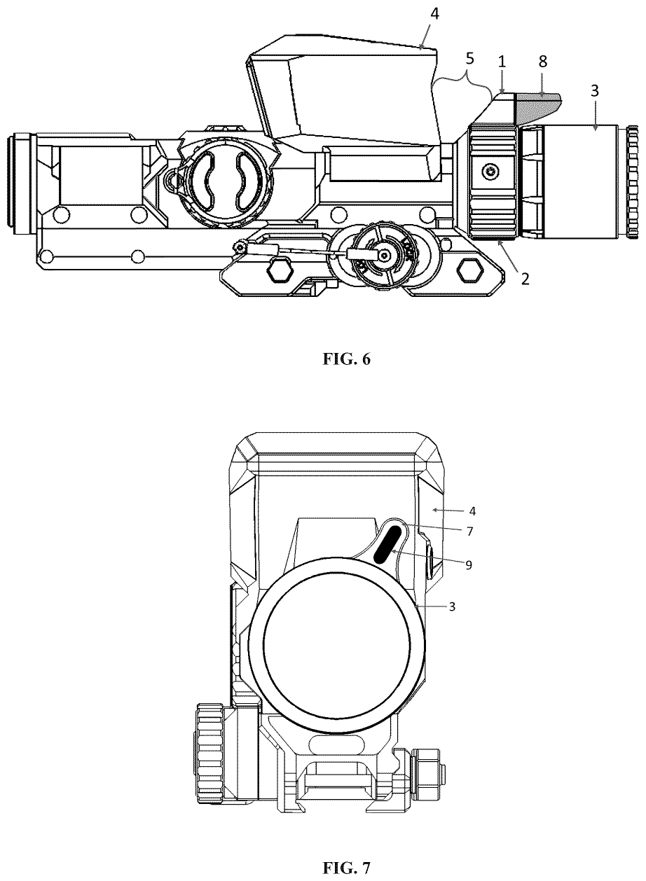

Another representative non-limiting embodiment of an extension for a magnification throw lever is shown in FIGS. 6 and 7. In one embodiment, the magnification throw lever extension is a polymer wing (8). The wing (8) is coupled to the magnification throw lever (1) via an MLOK slot (9) and is secured via a compatible screw and a nut.

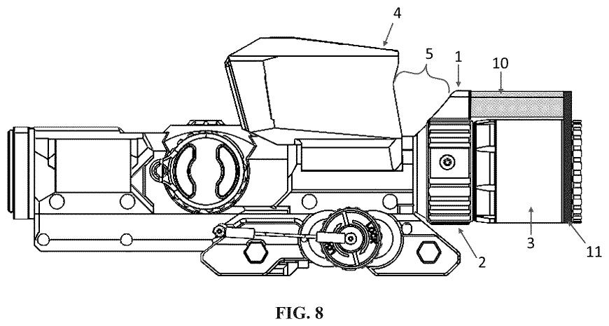

Another representative non-limiting embodiment of an extension for a magnification throw lever is shown in FIG. 8. In one embodiment, the magnification throw lever extension consists of a long lever (10) that is the length of about the eyepiece (3). The long lever (10) is coupled to the magnification throw lever via multiple bolts (16) threaded directly into the magnification throw lever (1). The long lever (10) also has a support ring (11) that encircles the eyepiece (3), which can be used to help prevent too much torque being applied to the connection of the magnification throw lever (1) and the long lever (10).

In one embodiment, the support ring may or may not touch the eyepiece. The support ring (11) may be integral to the long lever (10), or it may be separately attached. The support ring (11) may be monolithic or a consist of multiple parts. The support ring (11) may be solid all the way around the eyepiece (3), or it may be a split ring design.

In another embodiment, there may be multiple support rings or attachment points. In one embodiment, there is more than one support ring, including but not limited to 2 or 3 or 4 support rings. The support ring may be any suitable thickness or size.

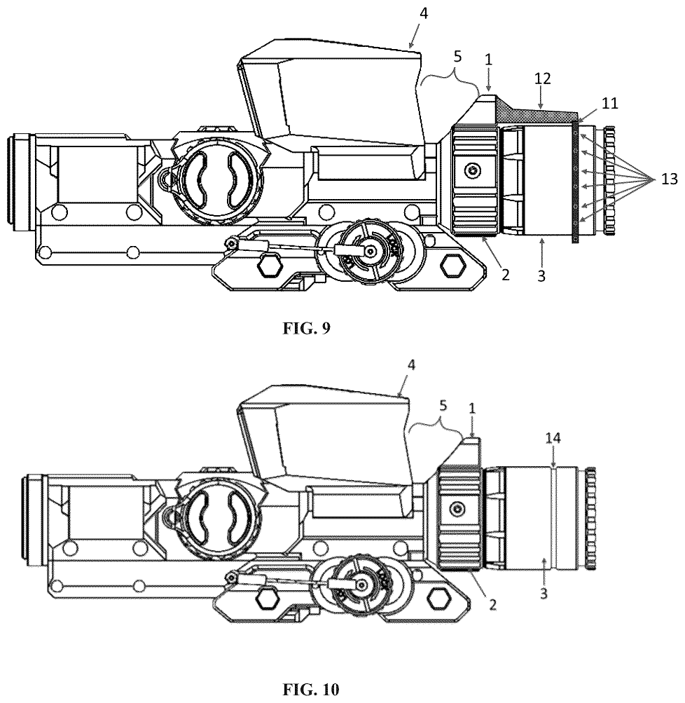

Another representative non-limiting embodiment of an extension for a magnification throw lever is shown in FIGS. 9 and 10. The magnification throw lever extension consists of a low-profile lever (12) that extends most of the length of the eyepiece (3). The support ring (11) is a split ring design and houses ball bearings (13) that ride inside a groove (14) in the eyepiece (3). The support ring and the groove may have a sealing mechanism built in to minimize dirt and debris getting into the design.

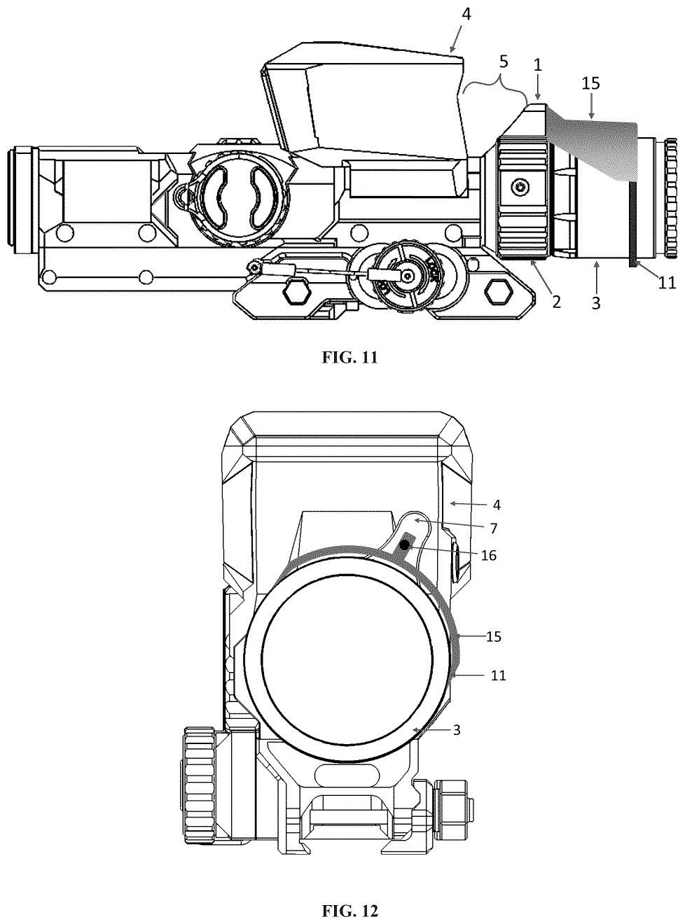

Another representative non-limiting embodiment of an extension for a magnification throw lever is shown in FIGS. 11 and 12. The magnification throw lever extension is a shroud (15) that semi encircles the eyepiece (3). In one embodiment, the shroud (15) may have a stand off from the eyepiece (3). one embodiment, the shroud (15) may not have a stand off from the eyepiece (3). In one embodiment, the shroud may have a support ring (11). In one embodiment, the shroud may not have a support ring (11).

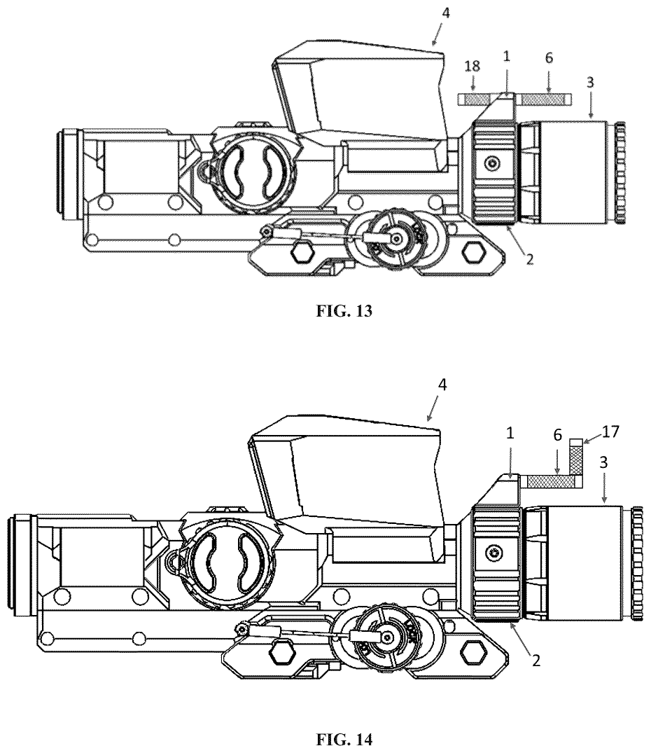

Another representative non-limiting embodiment of an extension for a magnification throw lever is shown in FIG. 13. The magnification throw lever could have both a knurled metal extension (6) oriented rearward toward the user and a forward-facing extension (18) to maximize the surface area.

Another representative non-limiting embodiment of an extension for a magnification throw lever is shown in FIG. 14. The magnification throw lever extension could have a hook (17) or another protrusion on it to help aid the user in grabbing the magnification throw lever extension.

### Active Display

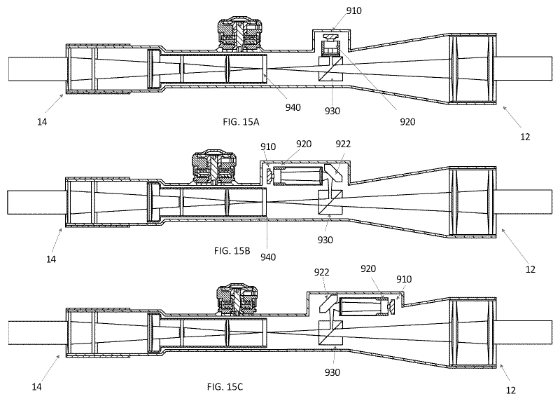

In one embodiment, the viewing optic has an active display. Representative, non-limiting configurations are shown in FIGS. 15A-15C.

In one embodiment, the active display 910 is controlled by a microcontroller or computer. In one embodiment, the active display is controlled by a microcontroller with an integrated graphics controller to output video signals to the display. In one embodiment, information can be sent wirelessly or via a physical connection into the viewing optic via a cable port. In still another embodiment, numerous input sources can be input to the microcontroller and displayed on the active display.

In one embodiment, the active display can be a reflective, transmissive or an emissive micro-display including but not limited to a micro display, transmissive active matrix LCD display (AMLCD), Organic light-emitting diode (OLED) display, Light-Emitting Diode (LED) display, e-ink display, a plasma display, a segment display, an electroluminescent display, a surface-conduction electron-emitter display, a quantum dot display, etc.

In one embodiment, the LED array is a micro-pixelated LED array, and the LED elements are micro-pixelated LEDs (also referred to as micro-LEDs or uLEDs in the description) having a small pixel size generally less than 75 μm. In some embodiments, the LED elements may each have a pixel size ranging from approximately 8 μm to approximately 25 μm and have a pixel pitch (both vertically and horizontally on the micro-LED array) ranging from approximately 10 μm to approximately 30 μm. In one embodiment, the micro-LED elements have a uniform pixel size of approximately 14 μm (e.g., all micro-LED elements are the same size within a small tolerance) and are arranged in the micro-LED array with a uniform pixel pitch of approximately 25 μm. In some embodiments, the LED elements may each have a pixel size of 25 μm or less and a pixel pitch of approximately 30 μm or less.

In some embodiments, the micro-LEDs may be inorganic and based on gallium nitride light emitting diodes (GaN LEDs). The micro-LED arrays (comprising numerous uLEDs arranged in a grid or other array) may provide a high-density, emissive micro-display that is not based on external switching or filtering systems. In some embodiments, the GaN-based, micro-LED array may be grown on, bonded on, or otherwise formed on a transparent sapphire substrate.

In one embodiment, the sapphire substrate is textured, etched, or otherwise patterned to increase the internal quantum efficiency and light extraction efficiency (i.e., to extract more light from the surface of the micro-LEDs) of the micro-LEDs. In other embodiments, silver nanoparticles may be deposited/dispersed on the patterned sapphire substrate to coat the substrate prior to bonding the micro-LEDs to further improve the light efficiency and output power of the GaN-based micro-LEDs and of the micro-LED array.

In one embodiment, the active display can be monochrome or can provide full color, and in some embodiments, can provide multi-color. In other embodiments, other suitable designs or types of displays can be employed. The active display can be driven by electronics. In one embodiment, the electronics can provide display functions, or can receive such functions from another device in communication therewith.

In one embodiment, the active display can be part of a backlight/display assembly, module or arrangement, having a backlight assembly including a backlight illumination or light source, device, apparatus or member, such as an LED backlight for illuminating the active display with light. In some embodiments, the backlight source can be a large area LED and can include a first or an integrated lens for collecting and directing generated light to a second, illumination or condenser lens, for collecting, concentrating and directing the light onto active display, along display optical axis B, with good spatial and angular uniformity. The backlight assembly and the active display are able to provide images with sufficient high brightness luminance to be simultaneously viewed with a very high brightness real world view through optics, while being at low power.

The backlight color can be selected to be any monochrome color or can be white to support a full color microdisplay. Other backlight design elements can be included, such as other light sources, waveguides, diffusers, micro-optics, polarizers, birefringent components, optical coatings and reflectors for optimizing performance of the backlight, and which are compatible with the overall size requirements of the active display, and the luminance, power and contrast needs.

Representative examples of micro displays that can be used include but are not limited to: Microoled, including MDP01 (series) DPYM, MDP02, and MDP05; Emagin such as the SVGA, micro-displays with pixel pitches are 9.9×9.9 micron and 7.8×7.8 micron, and Lightning Oled Microdisplay, such as those produced by Kopin Corporation. Micro LED displays can also be used including but not limited to those produced by VueReal and Lumiode.

In one embodiment, the electronics working with the active display can include the ability to generate display symbols, format output for the display, and include battery information, power conditioning circuitry, video interface, serial interface and control features. Other features can be included for additional or different functionality of the display overlay unit. The electronics can provide display functions or can receive such functions from another device in communication therewith.

In one embodiment, the active display can generate images including but not limited to text, alpha-numeric, graphics, symbols, and/or video imagery, icons, etc., including active target reticles, range measurements and wind information, GPS and compass information, firearm inclination information, target finding, recognition and identification (ID) information, and/or external sensor information (sensor video and/or graphics), or images for situational awareness, for viewing through the eyepiece along with the images of the view seen through optics. The direct viewing optics can include or maintain an etched reticle and bore sight and retain high resolution.

In one embodiment, the utilization of an active display allows for a programmable electronic aiming point to be displayed at any location in the field of view. This location could be determined by the user (as in the case of a rifle that fires both supersonic and subsonic ammo and thus has two different trajectories and “zeros”) or could be calculated based upon information received from a ballistic calculator. This would provide a “drop compensated” aiming point for long range shooting that could be updated on a shot-to-shot interval.

In one embodiment, the active display can be oriented to achieve maximum vertical compensation. In one embodiment, the active display is positioned to be taller than it is wide.

In one embodiment, the viewing optic further comprises a processor in electronic communication with the active display.

In another embodiment, the viewing optic may include memory, at least one sensor, and/or an electronic communication device in electronic communication with the processor,

### Beam Combiner

In one embodiment, the main body of the viewing optic has a beam combiner 930. In one embodiment, the beam combiner is one or more prismatic lenses (the prismatic lenses constitute the beam combiner). In another embodiment, the main body of the riflescope has a beam combiner that combines images generated from an active display with images generated from the viewing optics along the viewing optical axis of the riflescope.

In one embodiment, a beam combiner is used to combine a generated image from an integrated display system with an image from an optical system for viewing an outward image, wherein the optical system is located in a main body of a riflescope, in front of a first focal plane 940 in the main body, and then the combined image is focused onto the first focal plane, such that the generated image and the viewed image did not move in relation to one another. With the combined image focused onto the first focal plane, an aiming reference generated by the integrated display system will be accurate regardless of adjustments to the movable erector system.

In one embodiment, a beam combiner can be aligned with the integrated display system along the display optical axis, and positioned along the viewing optical axis of the viewing optics of the main body of a riflescope, thereby allowing for the images from the integrated display to be directed onto the viewing optical axis for combining with the field of view of the viewing optics in an overlaid manner.

In another embodiment, the beam combiner and the integrated display system are in the same housing. In one embodiment, the beam combiner is approximately 25 mm from the objective assembly.

In one embodiment, the beam combiner is approximately 5 mm distance from the objective assembly. In one embodiment the beam combiner is positioned at a distance from the objective assembly including but not limited to from 1 mm to 5 mm, or from 5 mm to 10 mm or from 5 mm to 15 mm, or from 5 mm to 20 mm, or from 5 mm to 30 mm, or from 5 mm to 40 mm or from 5 to 50 mm.

In yet another embodiment, the beam combiner is positioned at a distance from the objective assembly including but not limited to from 1 mm to 4 mm, or from 1 mm to 3 mm, or from 1 mm to 2 mm.

In one embodiment, the beam combiner is positioned at a distance from the objective assembly including but not limited to at least 3 mm, at least 5 mm, at least 10 mm, and at least 20 mm. In yet another embodiment, the beam combiner is positioned at a distance from the objective assembly from 3 mm to 10 mm.

In another embodiment, the beam combiner is approximately 150 mm distance from the ocular assembly. In one embodiment the beam combiner is positioned at a distance from the ocular assembly including but not limited to from 100 mm to 200 mm or from 125 mm to 200 mm or from 150 mm to 200 mm or from 175 mm to 200 mm.

In one embodiment the beam combiner is positioned at a distance from the ocular assembly including but not limited to from 100 mm to 175 mm or from 100 mm to 150 mm or from 100 mm to 125 mm.

In one embodiment the beam combiner is positioned at a distance from the ocular assembly including but not limited to from 135 mm to 165 mm or from 135 mm to 160 mm or from 135 mm to 155 mm or from 135 mm to 150 mm or from 135 mm to 145 mm or from 135 mm to 140 mm.

In one embodiment the beam combiner is positioned at a distance from the ocular assembly including but not limited to from 140 mm to 165 mm or from 145 mm to 165 mm or from 150 mm to 165 mm or from 155 mm to 165 mm or from 160 mm to 165 mm.

In one embodiment the beam combiner is positioned at a distance from the ocular assembly including but not limited to at least 140 mm or at least 145 mm or at least 150 mm or at least 155 mm.

In still another embodiment, the main body has a beam combiner, wherein the beam combiner is located beneath the elevation turret on the outside center part of the scope body.

In one embodiment, the beam combiner can have a partially reflecting coating or surface that reflects and redirects the output or at least a portion of the active display output from the integrated display system onto the viewing axis to the viewer's eye at eyepiece while still providing good transmissive see-through qualities for the direct viewing optics path.

In one embodiment, the beam combiner can be a cube made of optical material, such as optical glass or plastic materials with a partially reflective coating. The coating can be a uniform and neutral color reflective coating, or can be tailored with polarizing, spectrally selective or patterned coatings to optimize both the transmission and reflection properties in the eyepiece. The polarization and/or color of the coating can be matched to the active display. This can optimize reflectance and efficiency of the display optical path with minimal impact to the direct viewing optics transmission path.

Although the beam combiner is shown as a cube, in some embodiments, the beam combiner can have different optical path lengths for the integrated display system, and the direct viewing optics along viewing optical axis A. In some embodiments, the beam combiner can be of a plate form, where a thin reflective/transmissive plate can be inserted in the direct viewing optics path across the optical axis A.

In one embodiment, the position of the beam combiner can be adjusted in relation to the reflective material to eliminate any errors, including but not limited to parallax error. The position of the beam combiner can be adjusted using a screw system, a wedge system or any other suitable mechanism.

In one embodiment, the position of the beam combiner can be adjusted in relation to the erector tube to eliminate any errors, including but not limited to parallax error.

### Collector Lens System

In one embodiment, viewing optic can have a collector lens system 920 to collect light from the active display. In one embodiment, the viewing has an optical system based upon the use of optical lenses as a part of one or more lens cells, which include the lens itself and a lens cell body to which the lens is mounted. In one embodiment, the lens cell includes a precision formed body that is generally cylindrical, or disc shaped. This body has a central aperture for mounting the lens in alignment with an optical axis of a larger optical system. The cell body can also be said to have its own alignment axis, which will ultimately be aligned with the optical axis for the larger system when the lens cell is mounted therein. In addition, the lens cell serves as a “holder” for the lens, serves as a mechanism by which the lens can be mounted to and in the larger optical system, and (finally) serves as a means by which the lens can be manipulated by and for the purposes of that system.

In one embodiment, the integrated display system comprises a collector lens system, also referred to as a lens system. In one embodiment, the collector lens system comprises an inner lens cell and an outer lens cell.

### Reflective Material

In one embodiment, the viewing optic comprises a reflective material 922. In one embodiment, the reflective material 922 is a mirror. In one embodiment, the viewing optic comprises one or more mirrors. In one embodiment, the integrated display system comprises two, three, four or more mirrors.

In one embodiment, the mirror is positioned at an angle from 30° to 60°, or from 30° to 55°, 30° to 50°, or from 30° to 45°, or from 30° to 40°, or from 30° to 35° relative to the emitted light of the display.

In one embodiment, the mirror is positioned at an angle from 30° to 60°, or from 35° to 60°, 40° to 60°, or from 45° to 60°, or from 50° to 60°, or from 55° to 60° relative to the emitted light of the display.

In one embodiment, the mirror is positioned at an angle of at least 40°. In one embodiment, the mirror is positioned at an angle of 45° relative to the emitted light of the display.

In one embodiment, the position of the mirror can be adjusted in relation to the beam combiner to eliminate any errors, including but not limited to parallax error.

In one embodiment, the position of the mirror can be adjusted in relation to the active display to eliminate any errors, including but not limited to parallax error.

In one embodiment, the display for generating digital images are injected into the first focal plane of the main body, such that the digital image in the first focal plane is not tied to the movement of the erector tube.

In one embodiment, the active display is configured to emit light in a direction that is substantially parallel to an optical axis of the viewing scope.

In one embodiment, the active display is configured to emit light in a direction that is substantially perpendicular to an optical axis of the viewing scope.

In one embodiment, the mirror is oriented at an angle of approximately 45° relative to the emitted light of the display.

In one embodiment, the display and the mirror are located on a common side of the viewing optic main body.

In one embodiment, the display and the mirror are located on opposite sides of the viewing optic main body.

The viewing optic, systems, and throw lever extensions disclosed herein are further described, but not limited, by the following paragraphs:

1. An extension for a magnification throw lever substantially as shown and described herein.

2. A viewing optic comprising an extension for a magnification throw lever substantially as shown and descried herein.

3. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension coupled to the magnification throw lever.

4. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension threaded into an insert inside the magnification throw lever.

5. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and a polymer wing coupled to the magnification throw lever.

6. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and a polymer wing coupled to the magnification throw lever via an MLOK slot.

7. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension coupled to the magnification throw lever, wherein the extension is the length of the eyepiece, and a ring that encircles the ocular assembly.

8. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension threaded into the magnification throw lever, wherein the extension is the length of the eyepiece, a ring that encircles the ocular assembly, and an active display configured to generate an image, wherein the generated image and target image of the outward scene are combined in the first focal plane.

9. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, and an extension coupled to the magnification throw lever, and an active display configured to generate an image, wherein the generated image and target image of the outward scene are combined in the first focal plane.

10. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, and an extension threaded into an insert inside the magnification throw lever, and an active display configured to generate an image, wherein the generated image and target image of the outward scene are combined in the first focal plane.

11. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, a polymer wing coupled to the magnification throw lever, and an active display configured to generate an image, wherein the generated image and target image of the outward scene are combined in the first focal plane.

12. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, a polymer wing coupled to the magnification throw lever via an MLOK slot, and an active display configured to generate an image, wherein the generated image and target image of the outward scene are combined in the first focal plane.

13. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, an extension coupled to the magnification throw lever, wherein the extension is the length of the eyepiece, and a ring that encircles the ocular assembly, and an active display configured to generate an image, wherein the generated image and target image of the outward scene are combined in the first focal plane.

14. A viewing optic comprising: a body, an objective assembly coupled to a first end of the body configured to focus a target image from an outward scene to a first focal plane, an ocular assembly coupled to the second end of the body; a beam combiner located between the objective assembly and the first focal plane, an erector lens system, a magnification ring coupled to an external portion of the body; a magnification throw lever coupled to the magnification ring, an extension threaded into the magnification throw lever, wherein the extension is the length of the eyepiece, a ring that encircles the ocular assembly, and an active display configured to generate an image, wherein the generated image and target image of the outward scene are combined in the first focal plane.

The following Table provides a list of numerical identifiers and associated components that may be useful in understanding the embodiment disclosed herein.

| Number | Associated Label |
|---|---|
| 1 | magnification throw lever |
| 2 | magnification ring |
| 3 | eyepiece |
| 4 | LRF |
| 5 | working area |
| 6 | knurled metal extension |
| 7 | insert |
| 8 | wing |
| 9 | MLOK slot |
| 10 | long lever |
| 11 | support ring |
| 12 | low-profile lever |
| 13 | ball bearings |
| 14 | groove |
| 15 | shroud |
| 16 | bolts |
| 17 | hook |
| 18 | forward facing extension |
| 36 | Housing |
| 38 | Gun barrel |
| 120 | Objective Lens |
| 140 | Ocular Lens |
| 160 | variable power optical components |

All publications and patents mentioned in the above specification are herein incorporated by reference. Various modifications and variations of the described compositions and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modification are possible without departing from the scope of the invention as set forth in the appended claims. Indeed, various modifications of the described modes for carrying out the invention which are obvious to those skilled in marksmanship, computers or related fields are intended to be within the scope of the following claims.

What is claimed is:

1. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, and an extension coupled to the magnification throw lever.

2. The viewing optic of claim 1, wherein the extension is threaded into an insert inside the magnification throw lever.

3. The viewing optic of claim 2, wherein the extension is a knurled metal extension.

4. The viewing optic of claim 1, wherein the extension is a polymer wing.

5. The viewing optic of claim 4, wherein the polymer wing is coupled to the magnification throw lever through a MLOK slot.

6. The viewing optic of claim 1, wherein the extension is coupled to a ring that encircles the ocular assembly.

7. The viewing optic of claim 6, wherein the extension and the ring are a single, integrated unit.

8. The viewing optic of claim 6, wherein the extension is separable from the ring.

9. The viewing optic of claim 6, wherein the ring is a one piece unit.

10. The viewing optic of claim 6, wherein the ring is a split-design.

11. The viewing optic of claim 6, wherein the ring has ball bearings, and further wherein the ocular assembly has a groove to accept the ball bearings.

12. The viewing optic of claim 1, wherein the extension is a shroud.

13. The viewing optic of claim 1, wherein the extension has a hook configured to aid a user in accessing the extension.

14. The viewing optic of claim 1, wherein the extension is the length of the ocular assembly.

15. A viewing optic comprising: a body, an objective assembly coupled to a first end of the body configured to focus a target image from an outward scene to a first focal plane, an ocular assembly coupled to the second end of the body; an erector lens system, a magnification ring coupled to an external portion of the body; a magnification throw lever coupled to the magnification ring, an extension coupled to the magnification throw lever, and an active display configured to generate an image, wherein the generated image and target image of the outward scene are combined in the first focal plane.

16. The viewing optic of claim 15, wherein the extension is threaded into an insert inside the magnification throw lever.

17. The viewing optic of claim 15, wherein the extension is coupled to a ring that encircles the ocular assembly.

18. The viewing optic of claim 17, wherein the extension and the ring are a single, integrated unit.

19. The viewing optic of claim 17, wherein the extension is separable from the ring.

20. The viewing optic of claim 17, wherein the ring has ball bearings, and further wherein the ocular assembly has a groove to accept the ball bearings.
